(19) United States
(12) Patent Application Publication
(10) Pub. No.: US 2008/0266213 A1
(43) Pub. Date: Oct. 30, 2008

(54) PLASMA DISPLAY DEVICE AND AUTOMATIC POWER CONTROL METHOD FOR GENERATING ADDRESS DATA OF PLASMA DISPLAY DEVICE

(76) Inventor: Do-Wan Kim, Suwon-si (KR)

Correspondence Address: CHRISTIE, PARKER & HALE, LLP, PO BOX 7068, PASADENA, CA, 91109-7068, US

(21) Appl. No.: 12/111,024

(22) Filed: Apr. 28, 2008

(30) Foreign Application Priority Data
Apr. 27, 2007 (KR) 10-2007-0041616

(51) Int. Cl. G09G 3/28

(52) U.S. Cl. 345/63

(57) ABSTRACT

According to one embodiment, a plasma display device has a plurality of pixels for displaying images during frames using an input video signal, each of the frames being divided into a plurality of sub-fields, each of the sub-fields including a reset period, an address period, and a sustain discharge period, and the images having gray levels according to combined brightness weights of the sub-fields. The plasma display device includes an address power controller for reducing the gray level of a first pixel of the pixels by decreasing a sum of the brightness weights of the sub-fields, and for increasing the gray level of a second pixel of the pixels by increasing a sum of the brightness weights of the sub-fields, the second pixel being adjacent to the first pixel and the gray level of the second pixel being lower than the gray level of the first pixel.

### CROSS-REFERENCE TO RELATED PATENT APPLICATION

This application claims priority to and the benefit of Korean Patent Application No. 10-2007-0041616, filed on Apr. 27, 2007, in the Korean Intellectual Property Office, the entire content of which is incorporated herein by reference.

### BACKGROUND OF THE INVENTION

1. Field of the Invention

The present invention relates to a plasma display device and an automatic power control method for generating address data of the plasma display device.

2. Description of the Related Art

A plasma display device is a display device in which an image is formed by a phosphor material that is excited by ultraviolet rays generated by gas discharges. A large screen with high resolution can be realized by using the plasma display device. Thus, the plasma display device is expected to be a next generation flat panel display device.

Operation periods of sub-fields of the plasma display device include an address period in which cells for producing discharges are selected, a sustain discharge period in which the selected cells are turned on so as to form (or display) an image, and a reset period in which all cells are reset to have the same state.

Panel capacitors (or panel capacitances) exist in a plasma display panel (PDP) of the plasma display device since a discharge space between scan electrodes and sustain electrodes and a discharge space between a surface where address electrodes are formed and a surface where the scan and sustain electrodes are formed, act as capacitive loads. When sub-fields having operation periods as described above are operated, in order to supply a voltage signal having a certain waveform for an addressing operation, in addition to power required for an address discharge, more power is needed to inject electrical charges so as to generate a specific voltage for the panel capacitors. Here, still more power is required when the number of switching operations for the address electrodes increases.

Heat generation increases along with the increase in address power consumption, resulting in unstable system operation. Furthermore, excessive stress caused by the heat generation may damage switches of the plasma display device. In order to overcome these shortcomings, a method has conventionally been used to reduce the address power consumption. However, according to this method, gray levels of all pixels are reduced, and thus overall brightness degradation becomes severe. As a result, an image having a desired brightness cannot be obtained.

### SUMMARY OF THE INVENTION

An aspect of the present invention is directed to providing a plasma display device that reduces address power consumption and reduces brightness degradation.

Another aspect of the present invention is directed to providing a method of automatic power control for generating address data of the plasma display device, which reduces address power consumption and reduces brightness degradation.

According to one embodiment of the present invention, a plasma display device has a plurality of pixels for displaying images during frames using an input video signal, each of the frames being divided into a plurality of sub-fields, each of the sub-fields including a reset period, an address period, and a sustain discharge period, and the images having gray levels according to combined brightness weights of the sub-fields. The plasma display device includes an address power controller for reducing the gray level of a first pixel of the pixels by decreasing a sum of the brightness weights of the sub-fields, and for increasing the gray level of a second pixel of the pixels by increasing a sum of the brightness weights of the sub-fields, the second pixel being adjacent to the first pixel and the gray level of the second pixel being lower than the gray level of the first pixel.

During the address period, the address power controller may be adapted to decrease a number of the sub-fields in which the first pixel is selected and to increase a number of the sub-fields in which the second pixel is selected.

The address power controller may include: a gray level difference adder for adding gray level differences between adjacent pixels of the pixels to obtain a sum value; a memory for storing the gray levels of the adjacent pixels; a gain storage unit for storing gains based on the sum value; and a gain determining unit for determining and outputting the gains based on the sum value.

The gain storage unit may include: a high gray level pixel gain storage unit for storing a first gain of the gains, the first gain being for the first pixel; and a low gray level pixel gain storage unit for storing a second gain of the gains, the second gain being for the second pixel.

The gain determining unit may include: a high gray level pixel gain determining unit for determining a first gain of the gains, the first gain being for the first pixel; and a low gray level pixel gain determining unit for determining a second gain of the gains, the second gain being for the second pixel.

The plasma display device may further include an address data generator for correcting the input video signal by reducing the gray level of the first pixel by multiplying the first gain by the gray level of the first pixel, and by increasing the gray level of the second pixel by multiplying the second gain by the gray level of the second pixel.

According to another embodiment of the present invention, an automatic power control method for generating address data of a plasma display device is provided. The plasma display device has a plurality of pixels for displaying images during frames, each of the frames being divided into a plurality of sub-fields, each of the sub-fields including a reset period, an address period, and a sustain discharge period, and the images having gray levels according to combined brightness weights of the sub-fields. The automatic power control method includes: adding gray level differences between adjacent pixels to obtain a sum value; determining a first gain for a first pixel of the pixels and a second gain for a second pixel of the pixels, the second pixel being adjacent to the first pixel, and the gray level of the second pixel being lower than the gray level of the first pixel, wherein each of the first gain and the second gain corresponds to the sum value; decreasing the gray level of the first pixel by using the first gain; and increasing the gray level of the second pixel by using the second gain.

The sum value may include one of gray level differences between the adjacent pixels, the adjacent pixels being disposed in a row direction, gray level differences between the pixels of adjacent rows, or a total sum of the gray level differences between the adjacent pixels and the gray level differences between the pixels of the adjacent rows.

The decreasing the gray level of the first pixel by using the first gain may include reducing a sum of the brightness weights of the sub-fields.

The increasing the gray level of the second pixel by using the second gain may include increasing a sum of the brightness weights of the sub-fields.

The decreasing the gray level of the first pixel by using the first gain may include reducing a number of the sub-fields in which the first pixel is selected during the address period.

The increasing the gray level of the second pixel by using the second gain may include increasing a number of the sub-fields in which the second pixel is selected during the address period.

The determining the first gain and the second gain may include using a lookup table having experimental results.

### BRIEF DESCRIPTION OF THE DRAWINGS

The above and other features and aspects of the present invention will become more apparent by describing in detail exemplary embodiments thereof with reference to the attached drawings in which:

FIG. 1 is a schematic block diagram illustrating a plasma display device according to an embodiment of the present invention;

FIG. 2 is a schematic block diagram illustrating an address power controller (address APC) of the plasma display device shown in FIG. 1;

FIG. 3 illustrates an image displayed on a plasma display panel (PDP) in response to an original video signal;

FIG. 4 illustrates changes in gray levels of the image of FIG. 3 according to a conventional automatic power control method for generating address data;

FIG. 5 illustrates changes in gray levels of the image of FIG. 3 according to an embodiment of the present invention;

FIG. 6 is a graph illustrating a gamma curve showing changes in brightness when address power consumption is reduced by using the conventional automatic power control method for generating address data and by using the address automatic power control method of an embodiment of the present invention;

FIGS. 7 and 8 are tables showing address data for a line on/off pattern as illustrated in FIGS. 3 and 5, respectively, obtained during a unit frame; and

FIG. 9 is a flowchart illustrating an automatic power control method for generating address data according to an embodiment of the present invention.

### DETAILED DESCRIPTION

Hereinafter, exemplary embodiments of the present invention will be described with reference to the accompanying drawings.

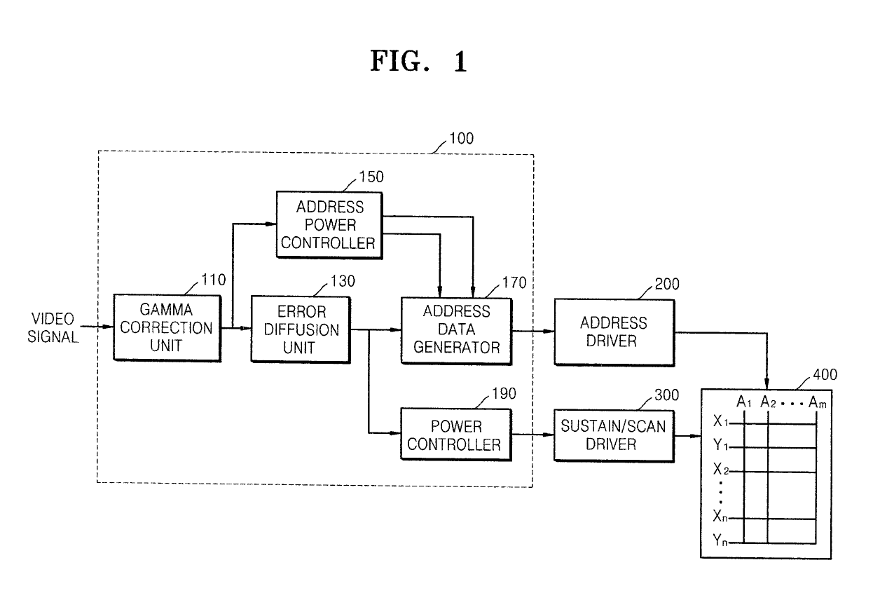

FIG. 1 is a schematic block diagram illustrating a plasma display device according to an embodiment of the present invention.

Referring to FIG. 1, the plasma display device includes a plasma display panel (PDP) 400 that includes sustain electrodes X and scan electrodes Y arranged in pairs and address electrodes A, an address driver 200 that supplies a specific signal to the address electrodes A, a sustain/scan driver 300 that supplies a specific signal to the sustain electrodes X and the scan electrodes Y, and a controller 100.

The controller 100 includes a gamma correction unit 110, an error diffusion unit 130, an address power controller (address APC) 150, an address data generator 170, and a power controller 190.

The gamma correction unit 110 maps a video signal having an n-bit grayscale to an inverse-gamma curve so that the video signal is corrected so as to be a video signal having an m-bit grayscale (where m≧n).

The error diffusion unit 130 error-diffuses the video signal, which has been corrected by using the inverse-gamma curve and is extended to have the m-bit grayscale, into adjacent pixels. In an error diffusion process, data contained in one or more lower significant bits of the video signal to be error-diffused is separated, and then the separated data is diffused to the adjacent pixels, thereby representing the data in a video format.

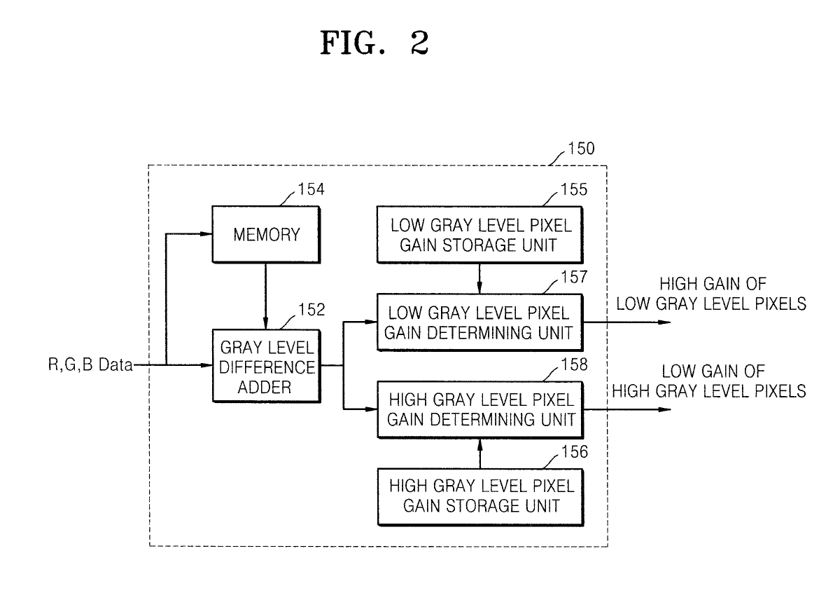

The address power controller (hereinafter, referred to as address APC) 150 determines whether unit frame data contained in the video signal, which has an m-bit grayscale and is inverse-gamma corrected, requires substantial address power consumption. Here, the address APC 150 allows address data to be reconfigured in order to control the power consumption. The address APC 150 decreases gray levels of pixels having high gray levels (i.e., pixels for displaying high gray level) and increases gray levels of pixels having low gray levels (i.e., pixels for displaying low gray level) so as to reduce gray level differences therebetween, thereby lowering the power consumption. Details thereof will be described later with reference to FIG. 2.

The address data generator 170 generates address data corrected by multiplying the video signal output from the error diffusion unit 130 by gains output from the address APC 150.

The power controller 190 uses the video signal output from the error diffusion unit 130 to determine a load factor (or load ratio). According to the determined load factor, the power controller 190 calculates an APC level to estimate the number of sustain discharge pulses (the number of sustain pulses) in association with the calculated APC level.

FIG. 2 is a schematic block diagram illustrating the address APC 150 of the plasma display device shown in FIG. 1.

Referring to FIG. 2, the address APC 150 includes a gray level difference adder 152, a memory 154, a low gray level pixel gain storage unit 155, a high gray level pixel gain storage unit 156, a low gray level pixel gain determining unit 157, and a high gray level pixel gain determining unit 158.

The gray level difference adder 152 adds gray level differences between consecutive pixels according to the video signal (e.g., R, G, and B data) having an m-bit grayscale that is gamma corrected and outputs the result to the gain determining units 157 and 158. In embodiments of the present invention, a sum of the gray level differences may be equal to the sum of gray level differences between pixels that are adjacent in a row direction, or the sum of gray level differences between lines (or rows) formed by a plurality of pixels that are arranged in a row direction, or a total sum of these two summation results. The sum of the gray level differences between the lines may be the sum of the gray level differences between pixels that are adjacent in a column direction.

A gray level difference sum Sp between adjacent pixels, a gray level difference sum SI between lines of pixels, and a total sum St of these two summation results can be expressed by Formulas 1, 2 and 3, respectively. In Formulas 1 and 2, Pi,j denotes a gray level of a pixel corresponding to an i-th row and a j-th column.

$$\begin{matrix}{S}_{p} = {\sum }_{i = 0}^{N} {\sum }_{j = 0}^{M} \vert {P}_{i , j + 1} - {P}_{i , j} \vert & Formula 1 \\ {S}_{l} = {\sum }_{i = 0}^{N} {\sum }_{j = 0}^{M} \vert {P}_{i + 1 , j} - {P}_{i , j} \vert & Formula 2 \\ S t = S p + S l & Formula 3\end{matrix}$$

The memory 154 stores a gray level of a previous pixel in association with the video signal (e.g., R, G, B data). The gray level of the previous pixel stored in the memory 154 is output to the gray level difference adder 152. Thereafter, the gray level difference adder 152 calculates differences between the gray level of the previous pixel and a gray level of a current pixel. Then, the gray level difference adder 152 adds the differences.

A sum value obtained from the gray level difference adder 152 is output to the gain determining units 157 and 158. The low gray level pixel gain determining unit 157 determines gains of low gray level pixels, and the high gray level pixel gain determining unit 158 determines gains of high gray level pixels.

The low gray level pixel gain determining unit 157 may determine an address APC level corresponding to the sum value. Furthermore, the low gray level pixel gain determining unit 157 may determine the gains of low gray level pixels corresponding to the address APC level by using a lookup table stored in the low gray level pixel gain storage unit 155. In one embodiment, the lookup table may be realized as a database having experimental results. The address APC level may be determined according to Formula 4. In Formula 4, a threshold value of the address APC level is a maximum address power consumption that does not affect a TCP load or the like and may be obtained from experimental results.

address APC level=St−threshold value of address APC level Formula 4

In one embodiment, the gain of the low gray level pixels may be greater than 1 since the video signal (e.g., R, G, and B data) is corrected so as to increase gray levels of the pixels having low gray level. Therefore, the gain of the pixels having low gray level is multiplied by a gray level of the video signal (R, G, and B data) to adjust to a desired gray level. Here, the gain of the pixels having low gray level is determined so as to produce a video signal having desired gray levels.

Likewise, the high gray level pixel gain determining unit 158 may determine an address APC level corresponding to the sum value. Furthermore, the high gray level pixel gain determining unit 158 may determine the gain of the pixels having high gray level corresponding to the address APC level by using a lookup table stored in the high gray level pixel gain storage unit 156. In one embodiment, the gain of the pixels having high gray level may be in the range of 0 to 1 since the video signal (e.g., R, G, B data) is corrected so as to decrease the gray levels of the pixels having high gray level. Therefore, the gain of the pixels having high gray level is multiplied by a gray level of the video signal (R, G, and B data) to adjust to a desired gray level. Here, the gain of the pixels having high gray level is determined so as to produce a video signal having the desired gray levels.

While the invention is primarily described in reference to a gain for pixels having low gray level and a gain for pixels having high gray level, in practice, multiple gains may correspond to pixels having low gray level, and multiple gains may correspond to pixels having high gray level.

Although the lookup tables of the low and high gray level pixels are separately created according to one embodiment, the present invention is not limited thereto. For example, a lookup table may be formed according to a conventional method of creating a database on the basis of a pixel gray level, a video signal (e.g., R, G, and B data), and a corrected video signal. Accordingly, once an address APC level is determined, it is possible to concurrently output gains for low and high gray level pixels corresponding to the address APC level.

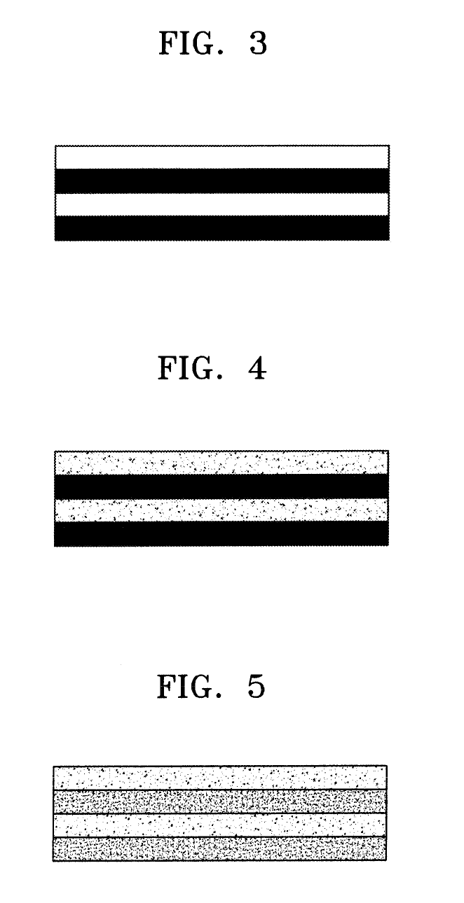

FIG. 3 illustrates an image displayed on a plasma display panel (PDP) in response to an original video signal. FIG. 4 illustrates changes in gray level of the image according to a conventional automatic power control method for generating address data. FIG. 5 illustrates changes in gray level of the image according to an embodiment of the present invention.

Referring to FIG. 3, an image having a stripe pattern (referred to as a ‘line on/off pattern’) in which brightness is clearly contrasted between lines. That is, pixels of first and third lines are selected during address periods of any sub-fields, and thus images are displayed in white, whereas pixels of second and fourth lines are not selected during address periods of all sub-fields, and thus images are displayed in dark. The pixels of the first and third lines are referred to as high gray level pixels. The pixels of the second and fourth lines are referred to as low gray level pixels. In one embodiment, in the line on/off pattern, a sum value is obtained by adding the sum of gray level differences of adjacent pixels between lines and the sum of gray level differences of adjacent pixels in individual lines. If the sum value is below a threshold value (e.g., a predetermined threshold value), it may not be necessary to control address power consumption for the line on/off pattern. Otherwise, in one embodiment, an address APC level corresponding to the total sum is determined.

Referring to FIG. 4, in the conventional method of reducing the address power consumption, gray levels of the high and low gray level pixels are both reduced. In other words, the sum value of all gray level differences is reduced. Thus, one gain can be obtained according to the determined address APC level. Furthermore, by utilizing the gain, the gray levels of the high and low gray level pixels are reduced as a whole.

In contrast, referring to FIG. 5, in a method of address automatic power control according to an embodiment of the present invention, the gray levels of the low and high gray level pixels are independently controlled, so that gains of the low and high gray level pixels can be separately output. Specifically, as described with reference to FIG. 2, the sum value of gray level differences is calculated, and then an address APC level corresponding to the sum value is determined. Thereafter, a gain of the low gray level pixels corresponding to the address APC level are obtained, for example, by using a lookup table having experimental results. Concurrently, a gain of the high gray level images corresponding to the address APC level can be obtained, for example, from a lookup table having experimental results. Alternatively, a mathematical expression derived experimentally may be used instead of a lookup table, and then the gains of the low and high gray level pixels corresponding to the sum value of gray level differences can be separately obtained by using the mathematical expression.

The gain of the low gray level pixels obtained as described above is multiplied by gray levels of the low gray level pixels so as to increase their gray levels. The gain of the high gray level pixels is multiplied by gray levels of the high gray level pixels so as to decrease their gray levels. Thus, gray levels decrease in the first and third lines constructed with pixels having high gray levels (high gray level pixels) and increase in the second and fourth lines constructed with pixels having low gray levels (low gray level pixels). Accordingly, it is possible to reduce the address power consumption due to the decrease in the sum of gray level differences between adjacent lines.

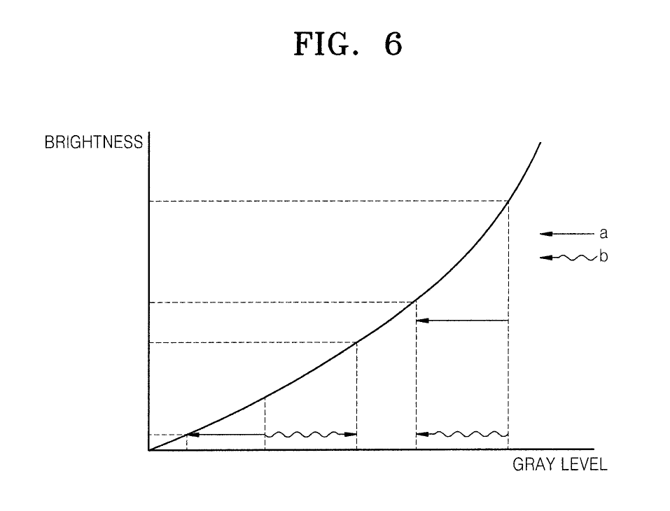

FIG. 6 is a graph illustrating a gamma curve showing changes in brightness when address power consumption is reduced by using the conventional automatic power control method for generating address data and by using the address automatic power control method of an embodiment of the present invention.

Referring to FIG. 6, according to the conventional automatic power control method for generating address data, gray levels of high and low gray level pixels are both reduced (indicated by a). The decrease in the gray levels generally causes brightness to be reduced. In contrast, according to the address automatic power control method of an embodiment of the present invention, gray levels of the low gray level pixels increase, while gray levels of the high gray level pixels decrease, thereby reducing a gray level difference. As a result, although brightness of the high gray level pixels decreases, brightness of the low gray level pixels increases. Therefore, brightness degradation, which occurs when the address power consumption is controlled, can be compensated for.

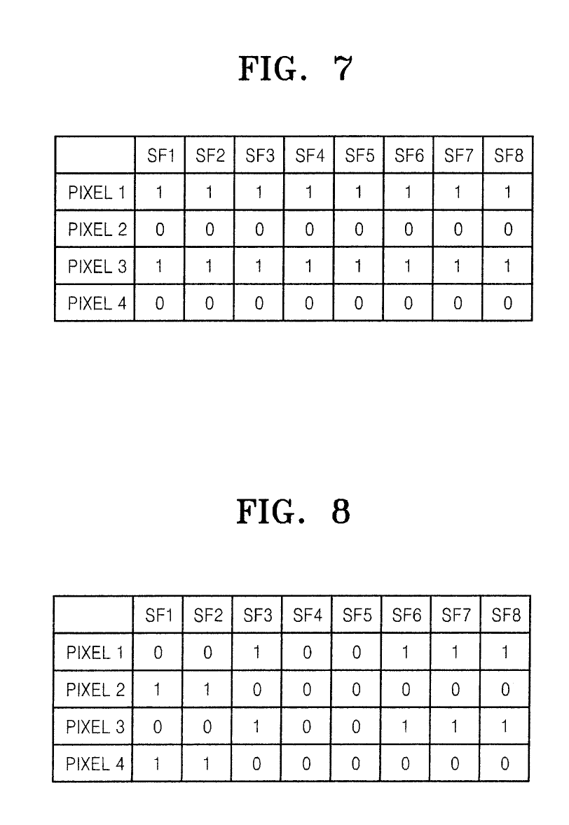

FIGS. 7 and 8 are tables showing address data corresponding to the line on/off pattern as illustrated, respectively, in FIGS. 3 and 5, obtained during a unit frame.

In order to display an image time divisionally, the unit frame is divided into eight sub-fields SF1 to SF8. Each of the sub-fields SF1 to SF8 is divided into a reset period, an address period, and a sustain discharge period. A time corresponding to 2ⁿ is assigned for a sustain discharge period Sn of an n-th sub-field SFn. When a pixel is appropriately selected in the eight sub-fields, a total of 256 gray levels can be displayed including a zero gray level which corresponds to not being selected in any of the sub-fields. Here, pixels are selected in a sub-field when discharges occur between the scan electrodes and the address electrodes during the address period. Accordingly, in the automatic power control method for generating address data of an embodiment of the present invention, the address power consumption is controlled by appropriately selecting pixels in sub-fields so as to obtain a desired gray level.

Referring to FIG. 7, address data of an original video signal indicating the line on/off pattern are shown. Specifically, a pixel 1 of a first line and a pixel 3 of a third line are selected in all of the eight sub-fields. Address data “1” denotes that a pixel is selected. The pixels 1 and 3 have 255 gray levels. A pixel 2 of a second line and a pixel 4 of a fourth line are not selected in the eight sub-fields and are indicated by address data “0”. The pixels 2 and 4 have zero gray levels. Relative to each other, the pixels 1 and 3 are high gray level pixels, whereas the pixels 2 and 4 are low gray level pixels. When sustain discharges occur according to the address data of the table shown in FIG. 7, an image as illustrated in FIG. 3 is formed. Here, address data in a vertical column of the table in association with an address electrode have a repeated pattern of “1”, “0”, “1”, and “0”. Thus, the number of address switching operations increases, thereby raising the address power consumption.

Referring to FIG. 8, in order to decrease the gray levels of the pixels 1 and 3, which are high gray level pixels, according to the automatic power control method for generating address data of an embodiment of the present invention, the number of sub-fields in which the pixels are selected is decreased. In an exemplary embodiment, instead of also selecting the pixels 1 and 3 in the first sub-field SF1, the second sub-field SF2, the fourth sub-field SF4, and the fifth sub-field SF5, the pixels 1 and 3 are selected in the rest of the sub-fields (i.e., the third sub-field SF3, the sixth sub-field SF6, the seventh sub-field SF7, and the eighth sub-field SF8). Thus, their gray levels are reduced to 228. In contrast, the pixels 2 and 4, which are low gray level pixels, are selected in the first sub-field SF1 and the second sub-field SF2. Thus, the pixels 2 and 4 have three gray levels of 3, thereby increasing gray levels of the low gray level pixels. Therefore, a gray level difference between the high gray level pixel and the low gray level pixel is reduced from 255 (255−0) to 225 (228−3). Furthermore, since address data is repeatedly applied in the sequence of “0”, “1”, “0”, and “1” in the first to third sub-fields SF1 to SF3 and in the sequence of “1”, “0”, “1”, and “0” in the sixth to eighth sub-fields SF6 to SF8, whereas no pixel is selected in the fourth and fifth sub-fields SF4 and SF5, the number of address switching operations is reduced, thereby decreasing the address power consumption.

The generating of address data of this embodiment is described merely for clarity of understanding, and the present invention is not limited thereto.

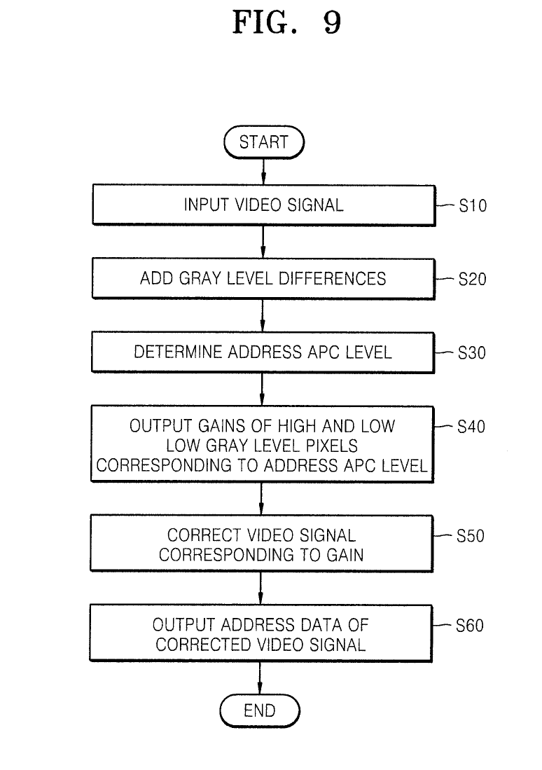

FIG. 9 is a flowchart illustrating an automatic power control method for generating address data according to an embodiment of the present invention.

Referring to FIG. 9, a video signal is input to an address power controller (operation S10).

Gray level differences between adjacent pixels in association with the video signal are added (operation S20). In this operation, the sum of the gray level differences may be equal to the sum of gray level differences between pixels that are adjacent in a row direction, or the sum of gray level differences between lines constructed with a plurality of pixels that are arranged in a row direction, or the total sum of these two summation results. The sum of the gray level differences between the lines may be the sum of the gray level differences between pixels that are adjacent in a column direction.

An address APC level corresponding to the sum of the gray level differences is determined (operation S30). The address APC level may be determined by using Formula 4. A threshold value of the address APC level is defined as an address APC level in association with address power consumption permissible in a plasma display device.

Gains corresponding to the address APC level are output (operation S40). The gains include a gain of high gray level pixels and a gain of low gray level pixels. In an embodiment of the present invention, power consumption is reduced by decreasing the gray levels of the high gray level pixels and by increasing the gray levels of the low gray level pixels. Thus, in one embodiment, for the high gray level pixels, a gain is for reducing a gray level, for example, a gain ranging from 0 to 1, whereas, for the low gray level pixels, a gain is for increasing a gray level, for example, a gain of 1 or higher.

If gains corresponding to the sum of the gray level differences are determined (e.g., immediately determined), the operation of determining the address APC level may be skipped.

The video signal is corrected by using the output gains (operation S50). Gray levels are multiplied by the output gains to obtain desired gray levels. Specifically, the gain (0 to 1) of the low gray level pixels is multiplied by the gray levels of the low gray level pixels, and the gain (1 or higher) of the high gray level pixels is multiplied by the gray levels of the high gray level pixels. Accordingly, by applying different gains for each pixel, a gray level difference between pixels is reduced, thereby correcting the video signal.

Address data of the corrected video signal is output (operation S60). Then, the procedure is ended.

According to an automatic power control method for generating address data of an embodiment of the present invention, the number of address switching operations is reduced in order to decrease address power consumption. In addition, brightness degradation can be compensated for without having to reduce an overall gray level. Therefore, it is possible to improve the reliability of a plasma display device in which the address power consumption is controlled.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims and their equivalents, and all differences within the scope will be construed as being included in the present invention.

What is claimed is:

1. A plasma display device having a plurality of pixels for displaying images during frames using an input video signal, each of the frames being divided into a plurality of sub-fields, each of the sub-fields including a reset period, an address period, and a sustain discharge period, and the images having gray levels according to combined brightness weights of the sub-fields, the plasma display device comprising:
an address power controller for reducing the gray level of a first pixel of the pixels by decreasing a sum of the brightness weights of the sub-fields, and for increasing the gray level of a second pixel of the pixels by increasing a sum of the brightness weights of the sub-fields, the second pixel being adjacent to the first pixel and the gray level of the second pixel being lower than the gray level of the first pixel.

2. The plasma display device of claim 1, wherein, during the address period, the address power controller is adapted to decrease a number of the sub-fields in which the first pixel is selected and to increase a number of the sub-fields in which the second pixel is selected.

3. The plasma display device of claim 1, wherein the address power controller comprises:
a gray level difference adder for adding gray level differences between adjacent pixels of the pixels to obtain a sum value;
a memory for storing the gray levels of the adjacent pixels;
a gain storage unit for storing gains based on the sum value; and
a gain determining unit for determining and outputting the gains based on the sum value.

4. The plasma display device of claim 3, wherein the gain storage unit comprises:
a high gray level pixel gain storage unit for storing a first gain of the gains, the first gain being for the first pixel; and
a low gray level pixel gain storage unit for storing a second gain of the gains, the second gain being for the second pixel.

5. The plasma display device of claim 3, wherein the gain determining unit comprises:
a high gray level pixel gain determining unit for determining a first gain of the gains, the first gain being for the first pixel; and
a low gray level pixel gain determining unit for determining a second gain of the gains, the second gain being for the second pixel.

6. The plasma display device of claim 5, further comprising an address data generator for correcting the input video signal by reducing the gray level of the first pixel by multiplying the first gain by the gray level of the first pixel, and by increasing the gray level of the second pixel by multiplying the second gain by the gray level of the second pixel.

7. The plasma display device of claim 6, wherein the sum value includes one of gray level differences between the adjacent pixels, the adjacent pixels being disposed in a row direction, gray level differences between the pixels of adjacent rows, or a total sum of the gray level differences between the adjacent pixels and the gray level differences between the pixels of the adjacent rows.

8. The plasma display device of claim 1, further comprising:
a PDP (plasma display panel) including address electrodes, and sustain electrodes and scan electrodes arranged in pairs;
an address driver for supplying a first signal to the address electrodes; and
a sustain scan driver for supplying a second signal to the sustain electrodes and the scan electrodes.

9. The plasma display device of claim 8, further comprising a controller for receiving the input video signal, for correcting the input video signal, and for applying the corrected video signal to the address driver and the sustain scan driver.

10. The plasma display device of claim 9, wherein the controller comprises the address power controller.

11. An automatic power control method for generating address data of a plasma display device, the plasma display device having a plurality of pixels for displaying images during frames, each of the frames being divided into a plurality of sub-fields, each of the sub-fields including a reset period, an address period, and a sustain discharge period, and the images having gray levels according to combined brightness weights of the sub-fields, the automatic power control method comprising:
adding gray level differences between adjacent pixels to obtain a sum value;
determining a first gain for a first pixel of the pixels and a second gain for a second pixel of the pixels, the second pixel being adjacent to the first pixel, and the gray level of the second pixel being lower than the gray level of the first pixel, wherein each of the first gain and the second gain corresponds to the sum value;
decreasing the gray level of the first pixel by using the first gain; and
increasing the gray level of the second pixel by using the second gain.

12. The automatic power control method of claim 11, wherein the sum value includes one of gray level differences between the adjacent pixels, the adjacent pixels being disposed in a row direction, gray level differences between the pixels of adjacent rows, or a total sum of the gray level differences between the adjacent pixels and the gray level differences between the pixels of the adjacent rows.

13. The automatic power control method of claim 11, wherein the decreasing the gray level of the first pixel by using the first gain comprises reducing a sum of the brightness weights of the sub-fields.

14. The automatic power control method of claim 11, wherein the increasing the gray level of the second pixel by using the second gain comprises increasing a sum of the brightness weights of the sub-fields.

15. The automatic power control method of claim 11, wherein the decreasing the gray level of the first pixel by using the first gain comprises reducing a number of the sub-fields in which the first pixel is selected during the address period.

16. The automatic power control method of claim 11, wherein the increasing the gray level of the second pixel by using the second gain comprises increasing a number of the sub-fields in which the second pixel is selected during the address period.

17. The automatic power control method of claim 11, wherein the determining the first gain and the second gain comprises using a lookup table having experimental results.

18. A plasma display device for displaying images during frames, each of the frames being divided into a plurality of sub-fields, each of the sub-fields including an address period, the plasma display device having a plurality of pixels for displaying the images having gray levels according to brightness weights of the sub-fields, the pixels including a high gray level pixel and a low gray level pixel, the gray level of the low gray level pixel being lower than the gray level of the high gray level pixel, the plasma display device comprising:
an address power controller for reducing the gray level of the high gray level pixel and for increasing the gray level of the low gray level pixel, the low gray level pixel being adjacent to the high gray level pixel.

19. The plasma display device of claim 18, wherein, during the address period of each of the sub-fields, the address power controller is adapted to decrease a number of the sub-fields in which the high gray level pixel is selected and to increase a number of the sub-fields in which the low gray level pixel is selected.

20. The plasma display device of claim 19, further comprising:
a plasma display panel comprising sustain electrodes, scan electrodes, and address electrodes;
an address driver for supplying a first signal to the address electrodes;
a sustain scan driver for supplying a second signal to the sustain and scan electrodes; and
a controller for receiving an input signal, correcting the input signal, and applying the corrected input signal to the address driver and the sustain scan driver,
wherein the controller comprises the address power controller.
